(19) United States
(12) Patent Application Publication
(10) Pub. No.: US 2005/0257070 A1
(43) Pub. Date: Nov. 17, 2005

(54) METHOD AND SYSTEM OF ACCESSING INSTRUCTIONS

(76) Inventors: Chih-Chiang Wen, Hsin-Chu Hsien (TW); Ping-Sheng Chen, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,066

(22) Filed: Aug. 20, 2004

(30) Foreign Application Priority Data
May 13, 2004 (TW) 093113416

(51) Int. Cl. H04L 9/00

(52) U.S. Cl. 713/190

(57) ABSTRACT

A method of accessing encrypted instructions includes utilizing an instruction access controller to access an encrypted instruction, utilizing a microprocessor to drive the instruction access controller to access the encrypted instruction, decrypting the encrypted instruction to generate a decrypted instruction, and utilizing the microprocessor to operate according to the decrypted instruction.

### BACKGROUND OF INVENTION

1. Field of the Invention

The present invention relates to a method and a system of accessing instructions of a microprocessor, and more particularly, to a method and a system of accessing instructions which access and decrypt encrypted instructions to make the microprocessor operate according to the decrypted instructions.

2. Description of the Prior Art

In a prior art disc player, a microprocessor accesses firmware stored in an external memory to operate and control the disc player for functions such as optimum power control (OPC) and track seeking. To prevent accessing the external memory through an external interface, various encryption mechanisms are developed to protect the stored data in the external memory. The encrypted instructions stored in the external memory are transmitted to a chip to decrypt through the external interface, and the microprocessor in the chip operates according to the decrypted instructions. Thus, even if the encrypted instructions are illegally accessed, the program codes corresponding to the encrypted instructions are still unavailable.

Please refer to FIG. 1. FIG. 1 is a diagram of an instruction access system 10 according to the prior art. The instruction access system 10 comprises a chip 12 and an external memory 14, wherein the chip 12 and the external memory 14 are electronically connected to each other. The external memory 14 is used to store encrypted instructions. The chip 12 comprises a direct memory access (DMA) controller 20, a memory controller 22, a decryption module 24, a storage apparatus 26, and a microprocessor 28. The DMA controller 20 is electronically connected to the memory controller 22 for accessing data of the external memory 14 using a DMA mode. As shown in FIG. 1, the memory controller 22 is electronically connected to the external memory 14 and the decryption module 24. The microprocessor 28 does not control data transmission. Instead, the DMA controller 20 controls the memory controller 22 to drive the memory controller 22 to access an encrypted instruction from the external memory 14 and transmit the encrypted instruction to the decryption module 24. The decryption module 24 is electronically connected to the storage apparatus 26. The storage apparatus 25 is electronically connected to the microprocessor 28, so the microprocessor 28 can access the decrypted instructions from the storage apparatus 26 to execute the decrypted instructions.

In the prior art instruction access system 10, the chip 12 accesses the instructions stored in the external memory 14 in units measured in pages. For example, a page of the external memory 14 corresponds to 1024 bits, so the chip 12 controls the external memory 14 to transmit 1024 bits of the encrypted data of a page to the decryption module 24 of the chip 12. However, the instruction access system 10 using the unit of page transmission not only requires high bandwidth to transmit encrypted instructions, but also uses a large amount of storage apparatus 26 to store decrypted instructions. Therefore, the chip 12 requires larger area. In addition, the storage apparatus 26 utilizes static random access memory (SRAM) to store decryption instructions. The input and output ports of the SRAM storage are easily probed in the physical layout of the chip 12, which increases the possibility of illegally accessing instructions. The chip 12 utilizes additional DMA controller 20 to access instructions, which further increases manufacturing cost, circuit complexity, and thus the area of the chip 12.

### SUMMARY OF INVENTION

It is therefore an objective of the claimed invention to provide a method and a system of accessing instructions, which decrypts in real-time the encrypted instructions to make the microprocessor operate according to the decrypted instructions, to solve the above-mentioned problems.

According to the claimed invention, a method of accessing instructions is disclosed. The method includes utilizing an instruction access controller to access the encrypted instruction, utilizing a microprocessor to drive the instruction access controller to access the encrypted instruction, decrypting the encrypted instruction to generate a decrypted instruction, and utilizing the microprocessor to operate according to the decrypted instruction.

The present invention further provides an instruction access system. The instruction access system includes a storage apparatus for storing encrypted instructions, an instruction access controller (IAC) electronically connected to the storage apparatus for accessing the encrypted instruction from the storage apparatus, a decrypted module electronically connected to the storage apparatus for decrypting the encrypted instruction to generate a decrypted instruction, and a microprocessor electronically connected to the instruction access controller and the decryption module for driving the instruction access controller to control the storage apparatus to transmit the encrypted instruction to the decryption module. The microprocessor receives the decrypted instruction from the decryption module to operate.

The method and the instruction access system according to the present invention do not need to utilize SRAM to store encrypted instructions, which reduces the chip area. In addition, the encrypted instructions outputted from the storage apparatus are directly transmitted to the decryption module to make the microprocessor operate according to the decrypted instructions, which reduces the probing possibility of the decrypted instructions. The method and the instruction access system according to the present invention do not employ the mechanism of DMA, so a DMA controller need not be configured in the chip. In summary, the method and the system of accessing instructions according to the present invention reduce the probing possibility of decrypted instructions and reduce manufacturing cost, circuit complexity, and the chip area.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an instruction access system according to the prior art.

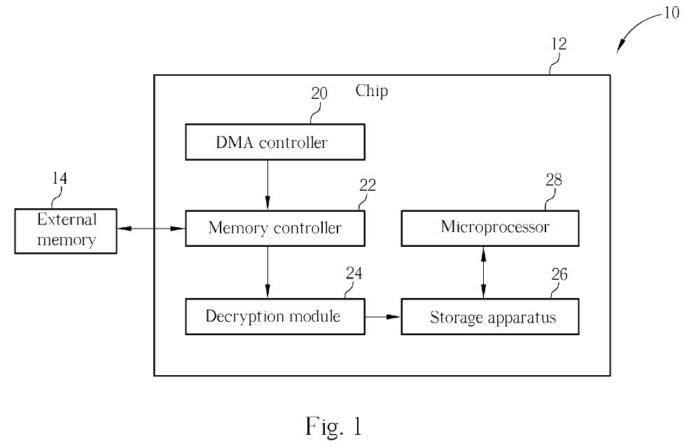

FIG. 2 is a diagram of an instruction access system according to a first embodiment of the present invention.

FIG. 3 is a flow chart illustrating operation of the instruction access system shown in FIG. 2.

FIG. 4 is a diagram of an instruction access system according to a second embodiment of the present invention.

FIG. 5 is a flow chart illustrating operation of the instruction access system shown in FIG. 4.

### DETAILED DESCRIPTION

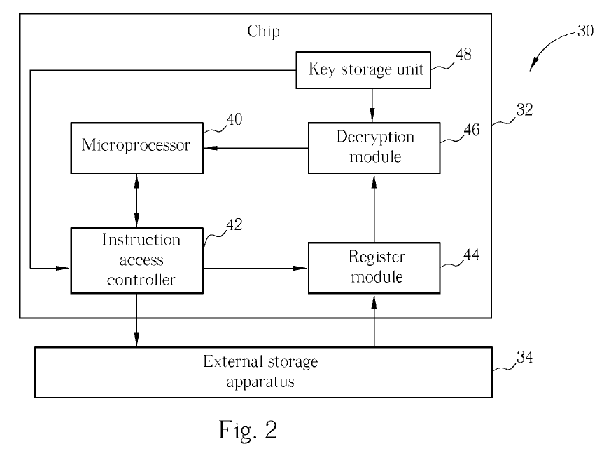

Please refer to FIG. 2. FIG. 2 is a diagram of an instruction access system 30 according to the first embodiment of the present invention. The instruction access system 30 comprises a chip 32 and an external storage apparatus 34, wherein the chip 32 and the external storage apparatus 34 are electronically connected to each other. The external storage apparatus 34 is used to store encrypted instructions. The chip 32 comprises a microprocessor 40, an instruction access controller (IAC) 42, an optional register module 44, a decryption module 46, and a key storage unit 48. The microprocessor 40 is electronically connected to the instruction access controller 42 for driving the instruction access controller 42 to access instructions. The instruction access controller 42 is electronically connected to the external storage apparatus 34, the register module 44, and the key storage unit 48 for accessing the encrypted instructions stored in the external storage apparatus 34 and controlling the encrypted instructions to store in the register module 44. The key storage unit 48 is used to store a key, and the instruction access controller 42 reads the key to decrypt the address of the encrypted instructions. The decryption module 46 is electronically connected to the microprocessor 40, the register module 44, and the key storage unit 48 for reading the key stored in another key storage unit 48 to decrypt the encrypted instructions stored in the register module 44. The decrypted instructions are transmitted to the microprocessor 40, which operates according to the decrypted instructions.

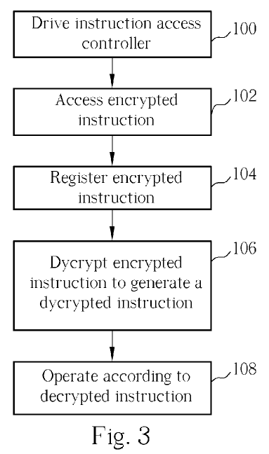

For a description of the detailed operation of the instruction access system 30, please refer to FIG. 3. FIG. 3 is a flow chart illustrating the operation of the instruction access system 30 shown in FIG. 2 and includes the following steps:

Step 100: The microprocessor 40 drives the instruction access controller 42 to access an encrypted instruction.

Step 102: The instruction access controller 42 decrypts the address of the encrypted instruction according to the key stored in the key storage unit 48 and accesses the encrypted instruction from the external storage apparatus 34.

Step 104: The register module 44 registers the encrypted instruction accessed from the external storage apparatus 34.

Step 106: The decryption module 46 decrypts the encrypted instruction stored in the register module 44 to generate a decrypted instruction according to the key stored in the key storage unit 48.

Step 108: The microprocessor 40 operates according to the decrypted instruction.

In this embodiment, the external storage apparatus 34 is a non-volatile memory, for example, an electrically erasable programmable read only memory (EEPROM) or a Flash ROM. The register module 44 is a volatile memory, for example, a FIFO. The key storage unit 48 can be located outside the chip 32. To describe clearly, assume the instruction access system 30 is applied to a disc player, the external storage apparatus 34 is used to store firmware, and the chip 32 is a controlling chip of the disc player. When the disc player receives a high-level instruction transmitted from the computer host for reading data in a specified track of a disc, the microprocessor 40 must execute the tracking program of the firmware to control the servo system to drive the pick-up head. Thus, the microprocessor 40 drives the instruction access controller 42 according to a first address stored in the external storage apparatus 34 (step 100). The instruction access controller 42 decrypts the first address according to the key stored in the key storage unit 48 and accesses the encrypted instruction stored in the external storage apparatus 34 according to the decrypted address (step 102). In addition, the instruction access controller 42 transmits a second address to the register module 44 for informing the register module 44 to register the encrypted instruction outputted from the external storage apparatus 34 in the second address (step 104). The decryption module 46 decrypts in real-time the encrypted instruction registered in the register module 44 and transmits the decrypted instruction to the microprocessor 40 (step 106). Finally, the microprocessor 40 receives the decrypted instruction corresponding to the tracking program code in the first address, and executes the decrypted instruction to control the tracking operation.

When the bandwidth between the chip 32 and the external storage apparatus 34 is shared, the instruction access system 30 can adjust the amount of accessed encrypted instructions according to the available bandwidth. That is, the instruction access controller 42 accesses more instructions and stores them in the register module 44 when the bandwidth is broad, which will improve the performance of the microprocessor for reducing the accessing times to the external storage apparatus 34. The instruction access controller 42 accesses fewer instructions and stores them in the register module 44 when the bandwidth is narrow, which reduces the area of the chip 32 by reducing the storage amount of the register module 44. When the bandwidth is extremely narrow, the instruction access controller 42 only accesses one instruction per time. Thus, the chip 32 need not use the register module 44 to register the encrypted instruction outputted from the external storage apparatus 34. That is, the encrypted instruction outputted from the external storage apparatus 34 is directly transmitted to the decryption module 46 to immediately generate the corresponding decrypted instruction.

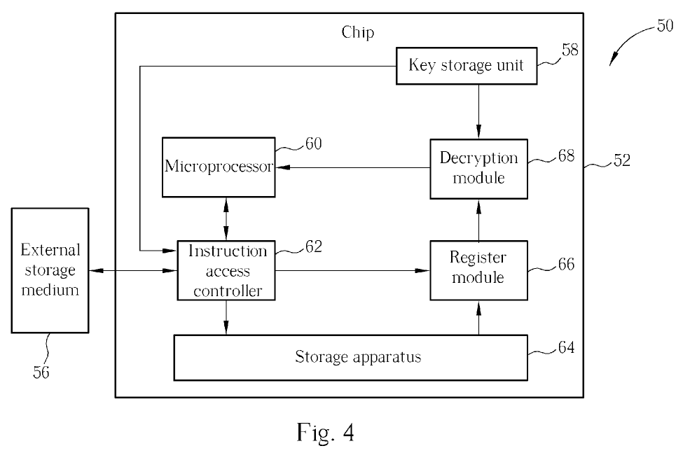

Please refer to FIG. 4. FIG. 4 is a diagram of an instruction access system 50 according to a second embodiment of the present invention. The instruction access system 50 comprises a chip 52 and an external storage medium 56, wherein the chip 52 and the external storage medium 56 are electronically connected to each other. The chip 52 comprises a key storage unit 58, a microprocessor 60, an instruction access controller (IAC) 62, a storage apparatus 64, a register module 66, and a decryption module 68. Please note that the components with the same names in the instruction access system 30 and the instruction access system 50 operate with the same function, so a redundant description is omitted. The main difference is that the storage apparatus 64 of the instruction access system 50 is embedded in the chip 52 and the encrypted instructions stored in the storage apparatus 64 are provided by the external storage medium 56 through the instruction access controller 62.

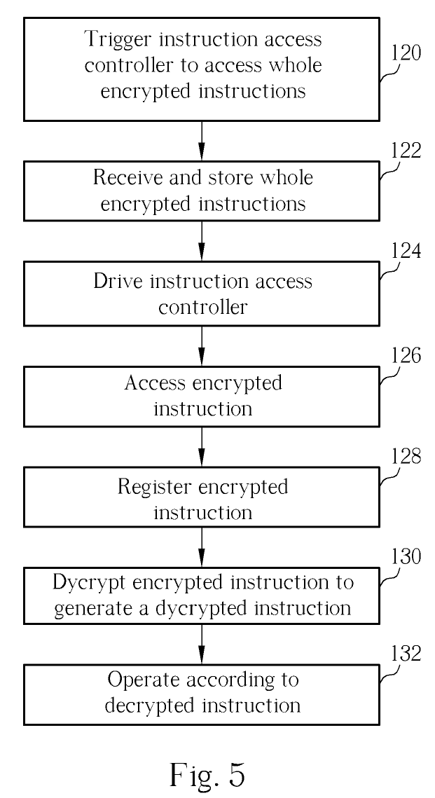

To describe the detailed operation of the instruction access system 50, please refer to FIG. 5. FIG. 5 is a flow chart illustrating operation of the instruction access system 50 shown in FIG. 4 and includes the following steps:

Step 120: The instruction access controller 62 is triggered to access whole encrypted instructions from the external storage medium 56.

Step 122: The instruction access controller 62 receives the whole encrypted instructions from the external storage medium 56 and stores them in the storage apparatus 64.

Step 124: The microprocessor 60 drives the instruction access controller 62 to access the encrypted instruction stored in the storage apparatus 64.

Step 126: The instruction access controller 62 decrypts the access address of the encrypted instruction according to the key stored in the key storage unit 58 and accesses the encrypted instruction from the storage apparatus 64.

Step 128: The register module 66 registers the encrypted instruction accessed from the storage apparatus 64.

Step 130: The decryption module 68 decrypts the encrypted instruction stored in the register module 66 to generate a decrypted instruction according to the key stored in the key storage unit 58.

Step 132: The microprocessor 60 operates according to the decrypted instruction.

In this embodiment, the external storage medium 56 is a non-volatile memory, a computer host, or a hard disc. The storage apparatus 64 and the register module 66 both are volatile memories, for example, dynamic random access memories (DRAM). The register module 66 is a cache memory composed of SRAM as an example. The key storage unit 58 can be located outside the chip 52. To describe clearly, assume the instruction access system 50 is applied to a disc player, the external storage medium 56 is used to store firmware, and the chip 52 is a controlling chip of the disc player. When the computer host is powered on to drive the disc player, the chip 52 initially drives the instruction access controller 62 to access the encrypted program codes from the external storage medium 56 (step 120). The instruction access controller 62 receives the encrypted program codes and stores a plurality of encrypted instructions of the encrypted program codes in the storage apparatus 64 (step 122). When the disc player receives a high-level instruction transmitted from the computer host for reading data in a specified track of a disc, the microprocessor 60 must execute the tracking program of the firmware to control the servo system to drive the pick-up head. Thus, the microprocessor 60 drives the instruction access controller 62 according to a first address stored in the storage apparatus 64 (step 124). The instruction access controller 62 decrypts the first address according to the key stored in the key storage unit 58 and access the encrypted instruction stored in the storage apparatus 64 according to the decrypted address (step 126). In addition, the instruction access controller 62 transmits a second address to the register module 66 for informing the register module 66 to register the encrypted instruction outputted from the storage apparatus 64 in the second address (step 128). The decryption module 68 decrypts in real-time the encrypted instruction registered in the register module 66 and transmits the decrypted instruction to the microprocessor 60 (step 130). Finally, the microprocessor 60 receives the decrypted instruction corresponding to the tracking program code in the first address, and executes the decrypted instruction to control the tracking operation.

In the same way, the second embodiment utilizes the register module 66 as a cache memory. The instruction access controller 62 can access more instructions to store in the register module 66, which enhances the performance of the microprocessor 60 by reducing the accessing times. The instruction access controller 62 can also access one encrypted instruction per time. Thus, the chip 52 need not use the register module 66 to register the encrypted instruction outputted from the storage apparatus 64. That is, the encrypted instruction outputted from the storage apparatus 64 is directly transmitted to the decryption module 68 to immediately generate the corresponding decrypted instruction.

Please note that although the method and system of accessing instructions according to the embodiments of the present invention mentioned above are applied to disc players, the method and the system of accessing instructions according to the present invention are not limited to disc-player applications. All apparatuses that read and decrypt encrypted program codes are also within the scope of the present invention.

The method and the instruction access system according to the present invention do not utilize SRAM to access encrypted instructions, which reduces the chip area. In addition, the encrypted instructions outputted from the storage apparatus are directly transmitted to the decryption module to make the microprocessor operate according to the decrypted instructions, which reduces the probing possibility of the decrypted instructions. The method and the instruction access system according to the present invention do not employ the mechanism of DMA, so no DMA controller is needed in the chip. In summary, the method and the system of accessing instructions according to the present invention reduces the probing possibility of decrypted instructions and reduces the manufacturing cost, circuit complexity, and thus the chip area.

Those skilled in the art will readily observe that numerous modifications and alterations of the device may be made while retaining the teachings of the invention. Accordingly, that above disclosure should be construed as limited only by the metes and bounds of the appended claims.

1. A method of accessing an encrypted instruction, the method comprising:
utilizing an instruction access controller (IAC) to access the encrypted instruction;
utilizing a microprocessor to drive the instruction access controller to access the encrypted instruction;
decrypting the encrypted instruction to generate a decrypted instruction; and
utilizing the microprocessor to operate according to the decrypted instruction.

2. The method of claim 1, wherein the step of decrypting the encrypted instruction further comprises:
providing a register module; and
driving the register module to store the encrypted instruction accessed by the instruction access controller according to an address provided by the instruction access controller.

3. The method of claim 1, further comprising:
providing a key storage unit for storing a key;
wherein the step of decrypting the encrypted instruction further comprises reading the key to decrypt the encrypted instruction.

4. The method of claim 1, further comprising:
providing a key storage unit for storing a key;
wherein the step of accessing the encrypted instruction further comprises reading the key to decrypt the access address of the encrypted instruction

5. The method of claim 1, further comprising:
locating the instruction access controller and the microprocessor in a chip;
wherein the encrypted instruction is stored in a storage apparatus connected to the chip.

6. The method of claim 1, wherein the encrypted instruction is stored in a storage apparatus, the method further comprising:
locating the storage apparatus, the instruction access controller, and the microprocessor in a chip.

7. An instruction access system comprising:
a storage apparatus for storing an encrypted instruction;
an instruction access controller (IAC) electronically connected to the storage apparatus for accessing the encrypted instruction from the storage apparatus;
a decryption module electronically connected to the storage apparatus for decrypting the encrypted instruction to generate a decrypted instruction; and
a microprocessor electronically connected to the instruction access controller and the decryption module for driving the instruction access controller to control the storage apparatus to transmit the encrypted instruction to the decryption module, the microprocessor receiving the decrypted instruction from the decryption module to operate.

8. The instruction access system of claim 7, further comprising:
a register module electronically connected to the instruction access controller, the storage apparatus and the decryption module for storing the encrypted instruction according to an address provided by the instruction access controller and transmitting the encrypted instruction to the decryption module.

9. The instruction access system of claim 8, wherein the register module functions as a cache memory.

10. The instruction access system of claim 7, further comprising:
a key storage unit electronically connected to the decryption module for storing a key;
wherein the decryption module reads the key to decrypt the encrypted instruction.

11. The instruction access system of claim 7, further comprising:
a key storage unit electronically connected to the instruction access controller for storing a key;
wherein the instruction access controller reads the key to decrypt the access address of the encrypted instruction.

12. The instruction access system of claim 7, wherein the instruction access controller, the decryption module, and the microprocessor are located in a chip, and the storage apparatus is connected to the chip.

13. The instruction access system of claim 12, wherein the storage apparatus is a non-volatile memory.

14. The instruction access system of claim 12, wherein the chip is a controlling chip of a disc player, and the decrypted instruction is a firmware of the disc player.

15. The instruction access system of claim 7, wherein the storage apparatus, the instruction access controller, the decryption module, and the microprocessor are located in a chip.

16. The instruction access system of claim 15, wherein the storage apparatus is a volatile memory.

17. The instruction access system of claim 15, wherein the chip is a controlling chip of a disc player, and the decrypted instruction is a firmware of the disc player.
